(19) United States
(12) Patent Application Publication
(10) Pub. No.: US 2025/0190951 A1
(43) Pub. Date: Jun. 12, 2025

(54) SCHEDULE INFORMATION SYNCHRONIZATION METHOD AND APPARATUS, AND ELECTRONIC DEVICE

(71) Applicant: Beijing Zitiao Network Technology Co., Ltd., Beijing (CN)

(72) Inventors: Weilun GUO, Beijing (CN); Bo LI, Beijing (CN); Zhendong JIANG, Beijing (CN)

(21) Appl. No.: 18/921,836

(22) Filed: Oct. 21, 2024

Related U.S. Application Data
(63) Continuation of application No. PCT/CN2023/089786, filed on Apr. 21, 2023.

(30) Foreign Application Priority Data
Apr. 21, 2022 (CN) 202210426223.9

(51) Int. Cl. G06Q 10/1093

(52) U.S. Cl. CPC G06Q 10/1095

(57) ABSTRACT

The present disclosure relates to the technical field of the Internet, and particularly relates to a schedule information synchronization method and apparatus, and an electronic device. The method comprises: in response to a preset trigger, determining first record information of a target event corresponding to the trigger, wherein the first record information is record information in an event management application; acquiring a first event parameter of the target event from the first record information; and on the basis of the first event parameter, creating or updating, by means of a target calendar, first schedule information corresponding to the first event parameter, wherein the target calendar is a calendar in a calendar application, which is configured to carry the first schedule information.

### CROSS-REFERENCING OF RELEVANT APPLICATIONS

The present application is based on and claims the priority of the PCT application No. PCT/CN2023/089786 filed on Apr. 21, 2023 and the Chinese patent application No. 202210426223.9 filed on Apr. 21, 2022, entitled “A Schedule Information Synchronization Method and Apparatus, and An Electronic Device”. The entire contents of these applications are hereby incorporated by reference into the present application.

### TECHNICAL FIELD

The present disclosure relates to the technical field of the Internet, and in particular, to a schedule information synchronization method and apparatus, and an electronic device.

### BACKGROUND

With regard to enterprise event management, personnel are required to summarize event information in some event management processes and maintain same. Sometimes, it is also necessary to enter a calendar application to create corresponding schedule reminders to remind the handling of tasks involved in the event management processes. In the current event management method, the event information summary and maintenance process and schedule reminder creation process are very cumbersome, resulting in inefficient event management.

### SUMMARY

In order to solve the above technical problems or at least partially solve the above technical problems, the present disclosure provides a schedule information synchronization method, and thus the efficiency of event management can be improved.

In order to achieve the above objective, the technical solutions provided in the embodiments of the present disclosure are as follows:

In a first aspect, provided is a schedule information synchronization method, including:
in response to a preset trigger, determining first record information of a target event corresponding to the trigger, the first record information being record information in an event management application;
acquiring a first event parameter of the target event from the first record information; and
based on the first event parameter, creating or updating event information corresponding to the first event parameter by means of a target application.

As an optional implementation of the embodiments of the present disclosure, the based on the first event parameter, creating or updating event information corresponding to the first event parameter by means of a target application includes: based on the first event parameter, creating or updating first schedule information corresponding to the first event parameter by means of a target calendar, where the target calendar is a calendar configured to carry the first schedule information in a calendar application.

As an optional implementation of the embodiments of the present disclosure, the creating or updating first schedule information corresponding to the first event parameter by means of a target calendar includes: creating or updating conference information corresponding to the first schedule information.

As an optional implementation of the embodiments of the present disclosure, the target calendar is a calendar associated with the event management application in the calendar application.

As an optional implementation of the embodiments of the present disclosure, the based on the first event parameter, creating or updating first schedule information corresponding to the first event parameter by means of a target calendar includes:
based on the first event parameter, creating or updating first schedule information corresponding to the first event parameter in the target calendar;
determining participant information corresponding to the first schedule information; and
creating or updating the first schedule information in personal calendars associated with the participant information.

As an optional implementation of the embodiments of the present disclosure, the based on the first event parameter, creating or updating first schedule information corresponding to the first event parameter by means of a target calendar includes:
determining participant information corresponding to the first event parameter, the target calendar being a personal calendar associated with the participant information; and
based on the first event parameter, creating or updating the first schedule information in the personal calendar.

As an optional implementation of the embodiments of the present disclosure, the first event parameter includes at least one of the following information:
event time information, event location information, event description information, and participant information.

As an optional implementation of the embodiments of the present disclosure, the acquiring a first event parameter of the target event from the first record information includes:
determining a target progress status of the target event from the first record information; and
acquiring the first event parameter corresponding to the target progress status.

As an optional implementation of the embodiments of the present disclosure, the first record information is record information in a target spreadsheet in the event management application;
the acquiring the first event parameter corresponding to the target progress status includes:
determining at least one first field associated with the target progress status in the target spreadsheet; and
acquiring at least one item of information from the at least one first field, and determining the first event parameter based on the at least one item of information.

As an optional implementation of the embodiments of the present disclosure, the based on the first event parameter, creating or updating first schedule information corresponding to the first event parameter by means of a target calendar includes:
filling the at least one item of information into at least one second field of the first schedule information, where the at least one second field is a field in the first schedule information, and each second field is filled according to one or more items of the at least one item of information. As an optional implementation of the embodiments of the present disclosure, the filling the at least one item of information into at least one second field of the first schedule information includes:
acquiring an item of information from a first field, and splitting the item of information into a plurality of sub-information corresponding to a plurality of second fields; and
filling the plurality of sub-information into the plurality of second fields corresponding to the plurality of sub-information, respectively.

As an optional implementation of the embodiments of the present disclosure, the determining a target progress status of the target event from the first record information includes:
determining a target progress status corresponding to the target event from the first record information, the target progress status being one of at least one progress status corresponding to the target event, different progress statuses in the at least one progress status corresponding to different event parameters, and different progress statuses in the at least one progress status corresponding to different schedule generation rules;
the based on the first event parameter, creating or updating first schedule information corresponding to the first event parameter by means of a target calendar includes:
acquiring a target schedule generation rule corresponding to the target progress status; and
based on the target schedule generation rule and the first event parameter, creating or updating first schedule information corresponding to the first event parameter by means of the target calendar.

As an optional implementation of the embodiments of the present disclosure, the target progress status includes: a current progress status or a future progress status.

As an optional implementation of the embodiments of the present disclosure, the first record information is record information in a target spreadsheet in the event management application;
the trigger includes a trigger operation on a synchronization control associated with the first record information.

As an optional implementation of the embodiments of the present disclosure, the in response to a trigger operation from a user, determining first record information of a target event corresponding to the trigger operation includes:
in response to the trigger operation, in the case where it is determined that a target calendar associated with the event management application exists in the calendar application, determining first record information of a target event corresponding to the trigger operation;
alternatively,
in response to the trigger operation, in the case where it is determined that the target calendar associated with the event management application does not exist in the calendar application, creating the target calendar, and determining first record information of a target event corresponding to the trigger operation.

As an optional implementation of the embodiments of the present disclosure, before based on the first event parameter, creating or updating first schedule information corresponding to the first event parameter on a target calendar, the method also includes:
determining essential elements of schedule information;
the based on the first event parameter, creating or updating first schedule information corresponding to the first event parameter on a target calendar includes:
in the case where it is determined that the first event parameter includes information corresponding to the essential elements, based on the first event parameter, creating or updating first schedule information corresponding to the first event parameter on a target calendar.

As an optional implementation of the embodiments of the present disclosure, the method also includes:
in the case where it is determined that the first event parameter does not include the information corresponding to the essential elements, outputting at least one of the following prompt messages:
a prompt message for prompting to supplement the information corresponding to the essential elements;
a prompt message for prompting a failure in creating the schedule information; and
a prompt message for prompting a failure in updating the schedule information.

As an optional implementation of the embodiments of the present disclosure, the based on the first event parameter, creating or updating first schedule information corresponding to the first event parameter on a target calendar includes:
in the case where it is determined that second schedule information corresponding to the first record information exists in the target calendar, based on the first event parameter, updating the second schedule information to the first schedule information corresponding to the first event parameter;
alternatively,
in the case where it is determined that the schedule information corresponding to the first record information does not exist in the target calendar, based on the first event parameter, creating the first schedule information corresponding to the first event parameter in the target calendar.

As an optional implementation of the embodiments of the present disclosure, the preset trigger is a trigger that occurs in the event management application.

As an optional implementation of the embodiments of the present disclosure, the first event parameter includes mailbox information, and the target application includes a mailbox application corresponding to the mailbox information; the creating or updating event information corresponding to the first event parameter by means of a target application includes: sending an email to a mailbox corresponding to the mailbox information, the email containing event information generated based on the first event parameter.

As an optional implementation of the embodiments of the present disclosure, the email contains conference information generated based on the first event parameter.

In a second aspect, provided is a schedule information synchronization apparatus, including:
a determination module, configured to, in response to a preset trigger, determine first record information of a target event corresponding to the trigger, the first record information being record information in an event management application;
an acquisition module, configured to acquire a first event parameter of the target event from the first record information; and
a synchronization module, configured to, based on the first event parameter, create or update event information corresponding to the first event parameter by means of a target application.

As an optional implementation of the embodiments of the present disclosure, the based on the first event parameter, creating or updating event information corresponding to the first event parameter by means of a target application includes: based on the first event parameter, creating or updating first schedule information corresponding to the first event parameter by means of a target calendar, where the target calendar is a calendar configured to carry the first schedule information in a calendar application.

As an optional implementation of the embodiments of the present disclosure, the creating or updating first schedule information corresponding to the first event parameter by means of a target calendar includes: creating or updating conference information corresponding to the first schedule information.

As an optional implementation of the embodiments of the present disclosure, the target calendar is a calendar associated with the event management application in the calendar application.

As an optional implementation of the embodiments of the present disclosure, the synchronization module is specifically configured to:
based on the first event parameter, create or update first schedule information corresponding to the first event parameter in the target calendar;
determine participant information corresponding to the first schedule information; and
create or update the first schedule information in personal calendars associated with the participant information.

As an optional implementation of the embodiments of the present disclosure, the synchronization module is specifically configured to:
determine participant information corresponding to the first event parameter, the target calendar being a personal calendar associated with the participant information; and
based on the first event parameter, create or update the first schedule information in the personal calendar.

As an optional implementation of the embodiments of the present disclosure, the first event parameter includes at least one of the following information:
event time information, event location information, event description information, and participant information.

As an optional implementation of the embodiments of the present disclosure, the acquisition module is specifically configured to:
determine a target progress status of the target event from the first record information; and
acquire the first event parameter corresponding to the target progress status.

As an optional implementation of the embodiments of the present disclosure, the first record information is record information in a target spreadsheet in the event management application;
the acquisition module is specifically configured to:
determine at least one first field associated with the target progress status in the target spreadsheet; and
acquire at least one item of information from the at least one first field, and determining the first event parameter based on the at least one item of information.

As an optional implementation of the embodiments of the present disclosure, the synchronization module is specifically configured to:
fill the at least one item of information into at least one second field of the first schedule information, wherein the at least one second field is a field in the first schedule information, and each second field is filled according to one or more items of the at least one item of information.

As an optional implementation of the embodiments of the present disclosure, the synchronization module is specifically configured to:
acquire an item of information from a first field, and splitting the item of information into a plurality of sub-information corresponding to a plurality of second fields; and
fill the plurality of sub-information into the plurality of second fields corresponding to the plurality of sub-information, respectively.

As an optional implementation of the embodiments of the present disclosure, the acquisition module is specifically configured to:
determine a target progress status corresponding to the target event from the first record information, the target progress status being one of at least one progress status corresponding to the target event, different progress statuses in the at least one progress status corresponding to different event parameters, and different progress statuses in the at least one progress status corresponding to different schedule generation rules;
the synchronization module is specifically configured to:
acquire a target schedule generation rule corresponding to the target progress status; and
based on the target schedule generation rule and the first event parameter, create or update first schedule information corresponding to the first event parameter by means of the target calendar.

As an optional implementation of the embodiments of the present disclosure, the target progress status includes: a current progress status or a future progress status.

As an optional implementation of the embodiments of the present disclosure, the first record information is record information in a target spreadsheet in the event management application;
the trigger includes a trigger operation on a synchronization control associated with the first record information.

As an optional implementation of the embodiments of the present disclosure, the determination module is specifically configured to:
in response to the trigger operation, in the case where it is determined that a target calendar associated with the event management application exists in the calendar application, acquire first record information of a target event corresponding to the trigger operation;
alternatively,
in response to the trigger operation, in the case where it is determined that the target calendar associated with the event management application does not exist in the calendar application, create the target calendar, and acquire first record information of a target event corresponding to the trigger operation.

As an optional implementation of the embodiments of the present disclosure, the determination module is also configured to:
determine essential elements of schedule information;
the synchronization module is specifically configured to:
in the case where it is determined that the first event parameter includes information corresponding to the essential elements, based on the first event parameter, create or update first schedule information corresponding to the first event parameter on a target calendar.

As an optional implementation of the embodiments of the present disclosure, the schedule information synchronization apparatus also includes:
a prompt output module, configured to: in the case where it is determined that the first event parameter does not include the information corresponding to the essential elements, output at least one of the following prompt messages:
a prompt message for prompting to supplement the information corresponding to the essential elements;
a prompt message for prompting a failure in creating the schedule information; and
a prompt message for prompting a failure in updating the schedule information.

As an optional implementation of the embodiments of the present disclosure, the synchronization module is specifically configured to:
in the case where it is determined that second schedule information corresponding to the first record information exists in the target calendar, based on the first event parameter, update the second schedule information to the first schedule information corresponding to the first event parameter;
alternatively,
in the case where it is determined that the schedule information corresponding to the first record information does not exist in the target calendar, based on the first event parameter, create the first schedule information corresponding to the first event parameter in the target calendar.

As an optional implementation of the embodiments of the present disclosure, the preset trigger is a trigger that occurs in the event management application.

As an optional implementation of the embodiments of the present disclosure, the first event parameter includes mailbox information, and the target application includes a mailbox application corresponding to the mailbox information; the creating or updating event information corresponding to the first event parameter by means of a target application includes: sending an email to a mailbox corresponding to the mailbox information, the email containing event information generated based on the first event parameter.

As an optional implementation of the embodiments of the present disclosure, the email contains conference information generated based on the first event parameter.

In a third aspect, provided is an electronic device, including: a processor, a memory, and a computer program stored in the memory and runnable on the processor, when the computer program is executed by the processor, the schedule information synchronization method as claimed in the second aspect or any one of its optional implementations being implemented.

In a fourth aspect, provided is a computer-readable storage medium, including: a computer program stored on the computer-readable storage medium, when the computer program is executed by a processor, the schedule information synchronization method as claimed in the second aspect or any one of its optional implementations being implemented.

In a fifth aspect, provided is a computer program product, characterized in that when running on a computer, the computer program product causes the computer to implement the schedule information synchronization method as claimed in the second aspect or any one of its optional implementations.

### BRIEF DESCRIPTION OF THE DRAWINGS

The accompanying drawings herein, which are incorporated in and constitute a part of this specification, illustrate embodiments consistent with the present disclosure and, together with the specification, serve to explain the principles of the present disclosure.

In order to more clearly illustrate the embodiments of the present disclosure or the technical solutions in the prior art, the accompanying drawings required for use in the embodiments or the description of the prior art will be briefly introduced below. Obviously, for those of ordinary skill in the art, other accompanying drawings can be obtained based on these accompanying drawings without paying any creative labor.

FIG. 1 is a first flowchart of a schedule information synchronization method provided in an embodiment of the present disclosure;

FIG. 2 is a schematic diagram of a trigger operation on a synchronization control associated with first record information, provided in an embodiment of the present disclosure;

FIG. 3 is a schematic diagram of creating or updating first schedule information in a target calendar, provided in an embodiment of the present disclosure;

FIG. 4 is a second flowchart of a schedule information synchronization method provided in an embodiment of the present disclosure;

FIG. 5 is a third flowchart of a schedule information synchronization method provided in an embodiment of the present disclosure;

FIG. 6 is a fourth flowchart of a schedule information synchronization method provided in an embodiment of the present disclosure;

FIG. 7A is a first structural block diagram of a schedule information synchronization apparatus provided in an embodiment of the present disclosure;

FIG. 7B is a second structural block diagram of a schedule information synchronization apparatus provided in an embodiment of the present disclosure; and

FIG. 8 is a structural block diagram of an electronic device provided in an embodiment of the present disclosure.

### DETAILED DESCRIPTION

In order to more clearly understand the above objects, features and advantages of the present disclosure, the solutions of the present disclosure will be further described below. It should be noted that, in the absence of conflict, the embodiments of the present disclosure and the features in the embodiments may be combined with each other.

In the following description, many specific details are set forth to facilitate a full understanding of the present disclosure, but the present disclosure may also be implemented in other ways different from those described herein; it is obvious that the embodiments in the specification are only part of the embodiments of the present disclosure, rather than all of the embodiments.

In the current event management method, the event information summary and maintenance process and schedule reminder creation process are very cumbersome, resulting in inefficient event management. In order to solve the above technical problems, the embodiments of the present disclosure provide a schedule information synchronization method and apparatus, and an electronic device. Thus, data can be automatically extracted from the event management application, and a schedule can be automatically established based on the extracted data and synchronized to the calendar, which simplifies the processes of summarizing and maintaining event information and creating schedules, and improves the efficiency of event management.

The schedule information synchronization method and apparatus, and electronic device provided in the embodiments of the present disclosure may be implemented by a schedule information synchronization apparatus or an electronic device. The schedule information synchronization apparatus may be an electronic device or a functional module or functional entity in the electronic device. The above electronic device may be a mobile phone, a tablet computer, a laptop computer, a PDA, a vehicle-mounted terminal, a wearable device, an ultra-mobile personal computer (UMPC), a netbook or a personal digital assistant (PDA), a personal computer (PC), etc., which is not specifically limited in the embodiments of the present disclosure.

In the schedule information synchronization method provided in an embodiment of the present disclosure, in response to a preset trigger, first record information of a target event corresponding to the trigger is determined, the first record information being record information in an event management application; a first event parameter of the target event is acquired from the first record information; and based on the first event parameter, first schedule information corresponding to the first event parameter is created or updated by means of a target calendar, where the target calendar is a calendar configured to carry the first schedule information in a calendar application. Through this solution, an event management application can be used for event management. By means of the preset trigger, the first record information of the target event can be automatically extracted from the event management application, and the first event parameter of the target event can be acquired from the first record information. After that, the first schedule information corresponding to the first event parameter can be created or updated by means of the target calendar in the calendar application, so that the schedule information corresponding to the first event parameter can be automatically synchronized to the target calendar. By using this event management method, data can be automatically extracted from the event management application, and a schedule can be automatically established based on the extracted data and synchronized to the calendar, which simplifies the processes of summarizing and maintaining event information and creating schedules, and improves the efficiency of event management.

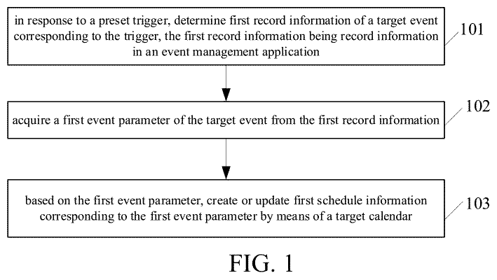

As shown in FIG. 1, a first flowchart of a schedule information synchronization method provided in an embodiment of the present disclosure is provided. The method includes the following steps 101 to 103:

101. In response to a preset trigger, determine first record information of a target event corresponding to the trigger, the first record information being record information in an event management application.

The event management application may be an application configured to manage any event task. For example, the event management application may be an object assessment management application, a training management application, a performance management application, a project management application, etc., which is not specifically limited in the embodiments of the present disclosure.

In some embodiments, the above preset trigger is a trigger that occurs in the event management application.

The above event management application can be used to manage a plurality of events in an event task. The target event can be an event involved in the event task.

Exemplarily, taking the event management application being an object assessment management application as an example, the event task is an object assessment task, which may include: object requirement management, object assessment progress management, object of assessment management, etc. The above target event may be an object assessment event involved in the object assessment progress management.

The above first record information may be stored and displayed in any manner in the event management application. In some embodiments, the first record information is record information in a target spreadsheet in the event management application. The target spreadsheet may be one or more spreadsheets in the event management application.

In some embodiments, when the first record information is information extracted from a plurality of spreadsheets, the plurality of spreadsheets have a certain association relationship.

The above preset trigger may be any form of trigger, for example, trigger methods such as a voice trigger, a triggering operation on a control associated with the first record information in the event management application, and preset trigger time and trigger conditions associated with the first record information. When the trigger time and trigger conditions associated with the first record information are met, the preset trigger is executed.

The control associated with the first record information may be a control component, a physical button, or a trigger link, etc., which is not limited in the embodiment of the present disclosure.

In some embodiments, the above trigger (i.e., preset trigger) includes a trigger operation on a synchronization control associated with the first record information. That is to say, the first record information of the target event corresponding to the trigger operation can be determined by means of the trigger operation on the synchronization control associated with the first record information, thereby realizing targeted creation of schedule information, i.e., creating schedule information for the target event.

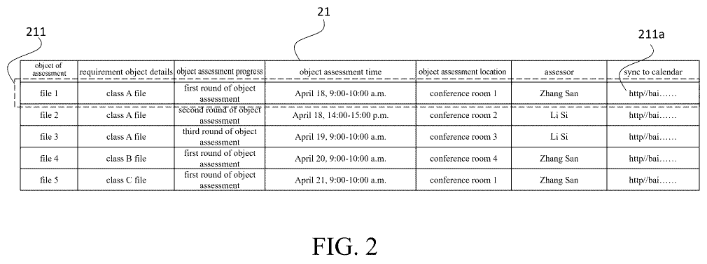

Exemplarily, as shown in FIG. 2, a schematic diagram of a trigger operation on a synchronization control associated with first record information, provided in an embodiment of the present disclosure is provided. In FIG. 2, by taking the event management application being an object assessment management application as an example, some record information of the object assessment event is recorded in a spreadsheet 21 in the object assessment management application, including first record information 211. The first record information 211 includes a plurality of fields in the spreadsheet 21. As shown in a “sync to calendar” field 211a, the field value filled in the field is a trigger link. By clicking the trigger link, the above step 101 can be executed.

102. Acquire a first event parameter of the target event from the first record information.

The first event parameter includes, but is not limited to, the following information:

### (1) Event Time Information;

The event time information may include an event start time, an event end time, and event end matters, etc.

Exemplarily, as shown in FIG. 2, in the first record information 211, the event is the object assessment event time, specifically a first round of object assessment in the object assessment event, and the object assessment time is “9:00-10:00 a.m. on April 18th”. “9:00-10:00 a.m. on April 18th” is then the event time information of the object assessment event.

### (2) Event Location Information;

In some embodiments, the event location information may include a location in an actual living space, or may include a virtual location.

Exemplarily, when the event location information is a location in an actual living space, the location may be a specific conference room, office or other place.

Exemplarily, when the event location information is a virtual location, the location may be a conference link of an online conference, or the name of a communication tool used to communicate the target event, etc.

### (3) Event Description Information;

The event description information includes: main information describing the target event, and remarks information for the target event.

The remarks information for the target event may include: information on the importance of the target event, and/or information such as precautions for the target event.

For example, for the first record information 211 shown in FIG. 2, a field “class A file” in the “requirement object details” and the object assessment progress “first round of object assessment” can be determined as event description information, which can be “first round of object assessment & class A file”. The values of other fields in FIG. 2 or other information outside FIG. 2 may also be used as event description information, which is not specifically limited in the embodiments of the present disclosure.

### (4) Participant Information

The participant information may include at least one of the following:

A participant ID and some information of the participant that is associated with the target event.

For example, for an object assessment event, the participant information may include: information about an object of assessment, and/or information about an assessor.

The information about the object of assessment may include: the ID of the object of assessment, and detailed introduction information of the object of assessment, etc. The information can help the assessor understand the general situation of the object of assessment and assist the assessor in examining the object of assessment during the assessment.

When there is relatively more content in some participant information, the participant information may be linked by means of a hyperlink, that is, the participant information included in the first event parameter may be a hyperlink to the participant information. For example, detailed information (such as the details and background introduction of a document to be assessed, the resume of a candidate, relevant documents of a project to be assessed, etc.) of the object of assessment may be linked by means of the hyperlink.

103. Based on the first event parameter, create or update event information corresponding to the first event parameter by means of a target application. In some embodiments, the update herein includes sending information, and may also include modifying the corresponding information.

In some embodiments, the based on the first event parameter, creating or updating event information corresponding to the first event parameter by means of a target application includes: based on the first event parameter, creating or updating first schedule information corresponding to the first event parameter by means of a target calendar.

The target calendar is a calendar configured to carry the first schedule information in a calendar application.

In the embodiments of the present disclosure, the calendar application and the object assessment management application are different types of applications.

In some embodiments, in the case where it is determined that second schedule information corresponding to the first record information exists in the target calendar, the second schedule information is updated to the first schedule information in the target calendar based on the first event parameter.

In some embodiments, in the case where it is determined that the schedule information corresponding to the first record information does not exist in the target calendar, first schedule information is created in the target calendar based on the first event parameter.

In some embodiments, the implementation method of, based on the first event parameter, creating or updating first schedule information corresponding to the first event parameter by means of a target calendar may include: filling at least one of the above event time information, event location information, event description information, and event participant information into at least one second field of the first schedule information.

The at least one second field is a field in the first schedule information, and each second field is filled according to one or more items of the at least one item of information.

That is, there is a certain correspondence between each first field in the first event parameter acquired in the first record information and each second field in the first schedule information, and the information in each first field needs to be filled into each second field according to the correspondence. In some embodiments, each first field may correspond to a second field, so that information in the at least one first field may be filled into the at least one second field in a one-to-one correspondence manner.

Exemplarily, assuming that the first event parameter includes the fields: object assessment time, object assessment location and assessor, and the first schedule information includes the fields: time, location and participant, the information in the field of object assessment time in the first event parameter can be filled into the field of time in the first schedule information; the information in the field of object assessment location can be filled into the field of location in the first schedule information; and the information in the field of assessor can be filled into the field of participant in the first schedule information.

In some embodiments, one or more first fields may correspond to one second field, so that, in some cases, it is necessary to merge the information in a plurality of first fields and then fill same into a second field corresponding to the plurality of first fields.

Exemplarily, assuming that the first event parameter includes the fields: requirement object details, object assessment progress, object assessment time, object assessment location and assessor, and the first schedule information includes the fields: time, location, participant and schedule title, the information in the field of object assessment time in the first event parameter can be filled into the field of time in the first schedule information; the information in the field of object assessment location can be filled into the field of location in the first schedule information; the information in the field of assessor can be filled into the field of participant in the first schedule information; and the information in both fields of requirement object details and object assessment progress can be filled into the field of schedule title in the first schedule information.

In some embodiments, one first field may also correspond to one or more second fields, so that, in some cases, it is necessary to split the information in one first field into a plurality of sub-information corresponding to a plurality of second fields, and then fill the plurality of sub-information into the plurality of second fields corresponding to the first field, respectively.

Exemplarily, assuming that the first event parameter includes the fields: object assessment time, object assessment location and participant, and the first schedule information includes the fields: date, time period, location and assessor, the information in the field of object assessment time in the first event parameter can be split into date information and time period information, and filled into the field of date and the field of time period in the first schedule information, respectively; the information in the field of object assessment location can be filled into the field of location in the first schedule information; and the information in the field of assessor can be filled into the field of participant in the first schedule information.

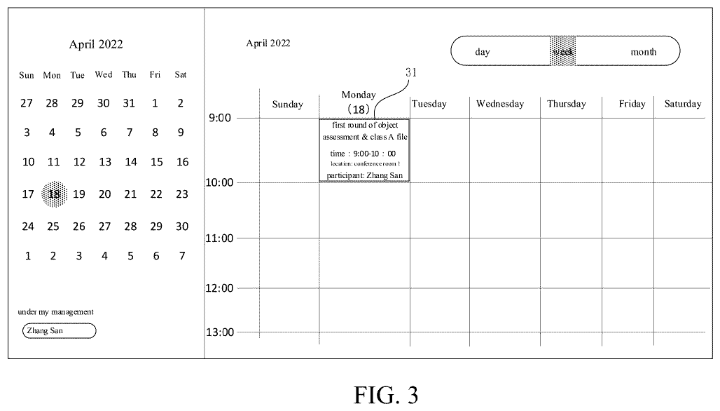

As shown in FIG. 3, a schematic diagram of creating or updating first schedule information in a target calendar, provided in an embodiment of the present disclosure is provided. In response to the click operation on the trigger link in the “sync to calendar” field 211a in FIG. 2 above, event parameters in the first record information 211 can be acquired, including: an object assessment time, an object assessment location and an assessor, and the first schedule information 31 as shown in FIG. 3 is created or updated in the calendar shown in FIG. 3. In the schedule information synchronization method provided in an embodiment of the present disclosure, in response to a preset trigger, first record information of a target event corresponding to the trigger is determined, the first record information being record information in an event management application; a first event parameter of the target event is acquired from the first record information; and based on the first event parameter, first schedule information corresponding to the first event parameter is created or updated by means of a target calendar, where the target calendar is a calendar configured to carry the first schedule information in a calendar application. Through this solution, an event management application can be used for event management. By means of the preset trigger, the first record information of the target event can be automatically extracted from the event management application, and the first event parameter of the target event can be acquired from the first record information. After that, the first schedule information corresponding to the first event parameter can be created or updated by means of the target calendar in the calendar application, so that the schedule information corresponding to the first event parameter can be automatically synchronized to the target calendar. By using this event management method, data can be automatically extracted from the event management application without human participation, and a schedule can be automatically established based on the extracted data and synchronized to the calendar, which simplifies the processes of summarizing and maintaining event information and creating schedules, and improves the efficiency of event management.

In some embodiments, the creating or updating first schedule information corresponding to the first event parameter by means of a target calendar includes: creating or updating conference information corresponding to the first schedule information. In this way, corresponding conference information can be created or updated intelligently and conveniently.

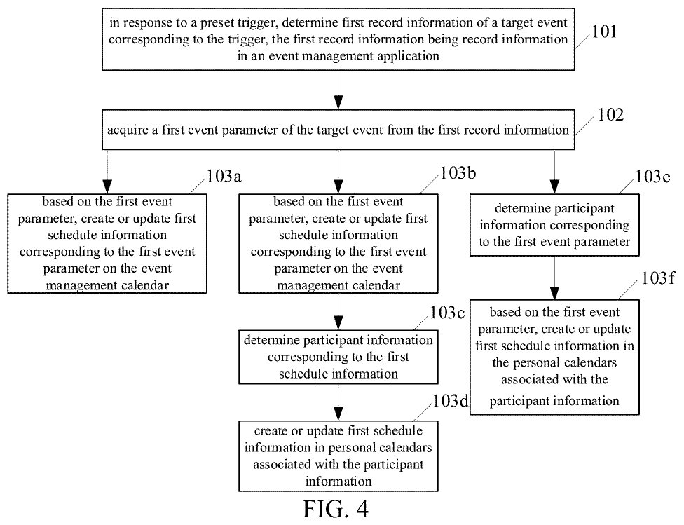

Exemplarily, as shown in FIG. 4 in combination with FIG. 1, a second flowchart of a schedule information synchronization method provided in an embodiment of the present disclosure is provided. In this method, step 103 in FIG. 1 can be implemented by not being limited to the following three cases, respectively:

Case 1: the target calendar is a calendar (hereinafter referred to as an event management calendar) associated with the event management application in the calendar application, and step 103 can be replaced by the following step 103a;

103a. Based on the first event parameter, create or update first schedule information corresponding to the first event parameter on the event management calendar.

In case 1, the event management calendar is associated with the event management application, so that calendar identity documents (IDs) of the event management calendar associated with the event management application are saved, and according to the calendar IDs, the first schedule information corresponding to the first event parameter can be created or updated on the event management calendar.

Case 2: the target calendar is a calendar (hereinafter referred to as an event management calendar) associated with the event management application in the calendar application, step 103 can be replaced by the following steps 103b to 103d;

103b. Based on the first event parameter, create or update first schedule information corresponding to the first event parameter on the event management calendar.

In case 1, the event management calendar is associated with the event management application, so that the calendar IDs of the event management calendar associated with the event management application are saved, and according to the calendar IDs, the first schedule information corresponding to the first event parameter can be created or updated on the event management calendar.

103c. Determine participant information corresponding to the first schedule information.

103d. Create or update first schedule information in personal calendars associated with the participant information.

Further, in the case where the participant information corresponding to the first schedule information is determined, the personal calendars associated with the participant information can be determined by determining the calendar IDs associated with the participant information, and the first schedule information can be created or updated in these personal calendars.

In some embodiments, acquiring personal calendars associated with the participant information may be pre-storing some correspondences between the participant information and the calendar IDs of the personal calendars, and determining the calendar IDs of the personal calendars associated with the participant information corresponding to the first schedule information by querying the pre-stored correspondences.

In other embodiments, after creating or updating the first schedule information corresponding to the first event parameter in the event management calendar, the above participant information can also be sent to the calendar application to request the calendar application for the calendar IDs corresponding to the above participant information, thereby determining the calendar IDs of the personal calendars associated with the participant information corresponding to the first schedule information.

Case 3: The target calendar is a personal calendar associated with the participant information in the calendar application, and step 103 can be replaced by the following steps 103e and 103f;

103e. Determine participant information corresponding to the first event parameter.

103f. Based on the first event parameter, create or update first schedule information in the personal calendars associated with the participant information.

In some embodiments, acquiring personal calendars associated with the participant information corresponding to the first event parameter may be pre-storing some correspondence between the participant information and the calendar IDs of the personal calendars, and determining the calendar IDs of the personal calendars associated with the participant information corresponding to the first event parameter by querying the pre-saved correspondences.

In other embodiments, the above participant information can be sent to the calendar application to request or instruct the calendar application to determine the calendar IDs corresponding to the above participant information, thereby determining the calendar IDs of the personal calendars associated with the participant information corresponding to the first event parameter.

The above three situations are only exemplary descriptions, and the first schedule information may also be created or updated on the target calendar in other ways, which are not limited in the embodiments of the present disclosure.

The present disclosure implements a variety of implementation methods for creating or updating first schedule information by means of a target calendar, so that the schedule information synchronization method provided in an embodiment of the present disclosure is rich and diverse in implementation methods that can be freely selected according to different application scenarios.

It should be noted that, in actual implementation, the above three situations usually do not occur at the same time. That is to say, in FIG. 4, after executing steps 101 and 102, in the case where step 103a is executed, steps 103b to 103d and steps 103e to 103f are usually not executed; after executing steps 101 and 102, in the case where steps 103b to 103d are executed, step 103a and steps 103e to 103f are usually not executed; and after executing steps 101 and 102, in the case where steps 103e to 103f are executed, step 103a and steps 103b to 103d are usually not executed.

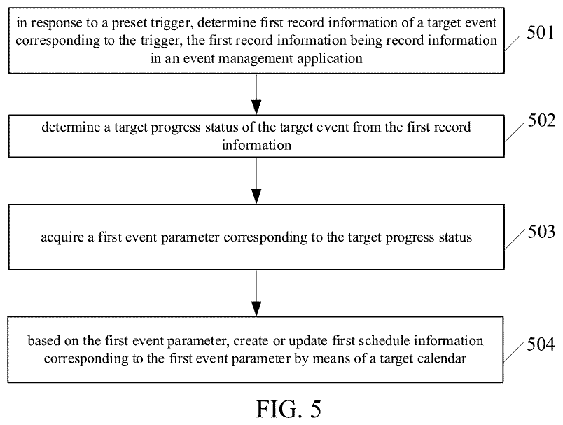

As shown in FIG. 5, a third flowchart of a schedule information synchronization method provided in an embodiment of the present disclosure is provided. The method includes the following steps 501 to 504:

501. In response to a preset trigger, determine first record information of a target event corresponding to the trigger, the first record information being record information in an event management application.

502. Determine a target progress status of the target event from the first record information.

The target event may correspond to at least one progress status. For example, for an object assessment event, the progress statuses that can be corresponded to include: a first round of object assessment, a second round of object assessment, a third round of object assessment, etc., respectively indicating an object assessment node of the round in which the object assessment event is located.

In some embodiments, different progress statuses in the at least one progress status may correspond to different event parameters, and/or different progress statuses in the at least one progress status correspond to different schedule generation rules. The schedule generation rules include, but are not limited to, conditions for generating a schedule, types of parameters included in the schedule, a final display style of the schedule, etc.

In some embodiments, determining a target progress status of the target event from the first record information may be determining the target progress status corresponding to the target event from the first record information. The target progress status is one of the at least one progress status corresponding to the target event.

Exemplarily, the progress statuses corresponding to the object assessment event include: a first round of object assessment, a second round of object assessment, a third round of object assessment, etc. If the first round of object assessment has passed, the current progress status determined at this time can be the second round of object assessment, and the future progress status can be the third round of object assessment.

In some embodiments, the target progress status includes: a current progress status or a future progress status. Since the event parameters corresponding to the progress status before the current progress status are already historical event parameters, there is no need to determine the progress status before the current progress status, but only to focus on the current progress status or the future progress status and acquire the corresponding first event parameter, thereby avoiding the need to schedule events that have already been executed and reducing interference.

503. Acquire a first event parameter corresponding to the target progress status.

In some embodiments, the first record information is record information in a target spreadsheet in the event management application. The target spreadsheet may be a spreadsheet or a plurality of associated spreadsheets in the event management application.

The above acquiring a first event parameter corresponding to the target progress status may be first determining at least one first field associated with the target progress status in the target spreadsheet; acquiring at least one item of information from the at least one first field, and determining the first event parameter based on the at least one item of information.

Determining the first event parameter based on the at least one item of information may be using the at least one item of information as the whole of the first event parameter, or using the at least one item of information as part of the first event parameter, or forming part or all of the first event parameter after appropriately processing the at least one item of information.

504. Based on the first event parameter, create or update first schedule information corresponding to the first event parameter by means of a target calendar.

In the process of, based on the first event parameter, creating or updating first schedule information corresponding to the first event parameter by means of a target calendar, a target schedule generation rule corresponding to the target progress status can be acquired first; and based on the target schedule generation rule and the first event parameter, schedule information corresponding to the first event parameter can be created or updated by means of the target calendar. That is to say, the conditions for generating a schedule, the types of parameters included in the schedule, the final display style of the schedule and other information corresponding to the current target progress status are first clarified, and the first schedule information corresponding to the first event parameter is then determined according to the information and the first event parameter.

In the above embodiment, in the process of determining a first event parameter from the first record information, the target progress status corresponding to the target event in the first record is first determined, and based on the target progress status, the first event parameter corresponding to the target progress status is screened out from the first record information. In this way, valid information can be extracted, and the acquisition of event parameters that do not match the progress status of the required creation schedule in the information extraction process can be avoided, thereby improving the accuracy in the information extraction process and avoiding extracting invalid information.

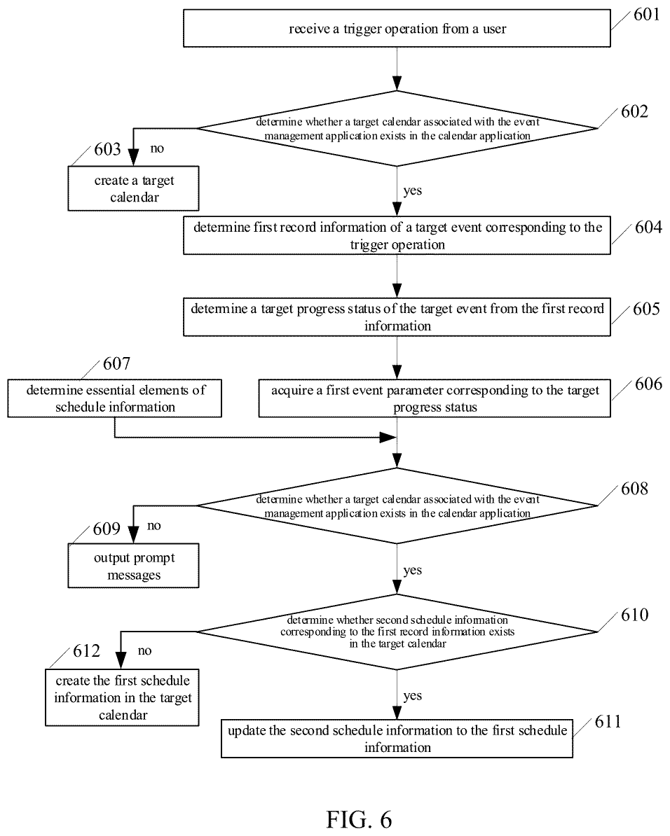

As shown in FIG. 6, a fourth flowchart of a schedule information synchronization method provided in an embodiment of the present disclosure is provided. The method includes:

601. Receive a trigger operation from a user.

The trigger operation may be a trigger operation on a control associated with the first record information in the event management application. The trigger operation is used to trigger the generation of a schedule based on the target event in the first record information and synchronize the schedule to calendars.

602. Determine whether a target calendar associated with the event management application exists in the calendar application.

In response to the trigger operation from the user, first record information of a target event corresponding to the trigger operation is determined. In response to the trigger operation, in the case where it is determined that a target calendar associated with the event management application exists in the calendar application, first record information of the target event corresponding to the trigger operation is determined; and in response to the trigger operation, in the case where it is determined that a target calendar associated with the event management application does not exist in the calendar application, the target calendar is created, and first record information of the target event corresponding to the trigger operation is determined.

Before generating a schedule based on the target event in the first record information and synchronizing the schedule to the calendars, it is necessary to first detect whether a target calendar associated with the event management application has been preset in the calendar application. If a target calendar associated with the event management application has been preset, subsequent steps 604 to 612 can be continued, and a schedule is continued to be generated based on the target event in the first record information and synchronized to the target calendar. If a calendar associated with the event management application has not been preset, a target calendar is first created and associated with the event management application, and a schedule is continued to be generated based on the target event in the first record information and synchronized to the target calendar, that is, step 603 is first executed, and subsequent steps 604 to 612 are continued.

603. Create a target calendar.

604. Determine first record information of a target event corresponding to the trigger operation.

605. Determine a target progress status of the target event from the first record information.

606. Acquire a first event parameter corresponding to the target progress status.

For the description of the above steps 604 and 605, the above related description of steps 501 to 503 can be referred to, which will not be repeated here.

In some embodiments, after determining the target progress status, it is also possible to determine whether the first record information includes event parameters that match the target progress status. If event parameters that match the target progress status do not exist, a prompt message can be output to prompt that event parameters that match the target progress status do not exist, so that users using the event management application can supplement event parameters that match the target progress status; alternatively, if event parameters that match the target progress status do not exist, an error will be reported to prompt that the target progress status is incorrect and no event parameter is matched, so as to prompt users using the event management application to check whether the target progress status is set incorrectly.

607. Determine essential elements of schedule information.

The essential elements of the schedule information need to include: information such as participant, time and location.

608. Determine whether the first event parameter includes the essential elements of the schedule information.

In some embodiments, before, based on the first event parameter, creating or updating first schedule information corresponding to the first event parameter on a target calendar, the essential elements of the schedule information can be determined first; and then, in the case where it is determined that the first event parameter include information corresponding to the essential elements, first schedule information corresponding to the first event parameter is created or updated on the target calendar based on the first event parameter.

By determining whether the first event parameter include the essential elements of the schedule information, it can be learned whether the first event parameter is sufficient to generate schedule information. For example, if the first event parameter does not include the time information in the essential element of the schedule information, the schedule information cannot be generated.

In the case where it is determined that the first event parameter include information corresponding to the essential elements, it means that the first event parameter can be sufficient to generate schedule information, and the following steps 610 to 612 can be executed at this time; in the case where it is determined that the first event parameter do not include information corresponding to the essential elements, it means that the first event parameter cannot generate schedule information, and the following step 609 is executed at this time.

609. Output prompt messages.

The above output of prompt messages may include outputting at least one of the following prompt messages including but not limited to:
1) A prompt message for prompting to supplement the information corresponding to the essential elements;

The prompt information may be displayed in the event management application, prompting users of the event management application to supplement, in the event management application, the information corresponding to the essential elements used to generate the schedule information in the first record information.
2) A prompt message for prompting a failure in creating the schedule information;
3) A prompt message for prompting a failure in updating the schedule information. In the embodiments of the present disclosure, by determining whether the first event parameter includes the essential elements of the schedule information, whether the first event parameter is complete and sufficient to generate first schedule information can be first determined before creating or updating the first schedule information corresponding to the first event parameter, which can avoid the situation that incomplete schedule information is obtained or the schedule information cannot be obtained after subsequent operations are performed in the case where the first event parameter is incomplete. On the one hand, subsequent invalid operations can be avoided to reduce power consumption and ensure the generation of complete schedule information; on the other hand, humanized prompt messages can be output to prompt to supplement the essential elements used to generate the schedule information in the first record information, thereby improving the human-computer interaction performance.

610. Determine whether second schedule information corresponding to the first record information exists in the target calendar.

In the case where it is determined that second schedule information corresponding to the first record information exists in the target calendar, the following step 611 is executed. Specifically, the following step 611 may be executed in the case where it is determined that second schedule information corresponding to the target progress status exists in the first record information;
in the case where it is determined that schedule information corresponding to the first record information does not exist in the target calendar, the following step 612 is executed. Specifically, the following step 612 is executed in the case where it is determined that second schedule information corresponding to the target progress status does not exist in the first record information.

611. Based on the first event parameter, update the second schedule information to the first schedule information corresponding to the first event parameter.

In some embodiments, updating the second schedule information to the first schedule information corresponding to the first event parameter may be modifying the second schedule information to the first schedule information, or deleting the second schedule information and recreating the first schedule information.

612. Based on the first event parameter, create the first schedule information corresponding to the first event parameter in the target calendar.

In the above embodiment, by determining whether second schedule information corresponding to the first record information exists in the target calendar, it can be learned whether the schedule information has been created based on the first record information. If the schedule information has been created, the original schedule information can be updated to the first schedule information; if the schedule information has not been created, the first schedule information can be created based on the first event parameter in the first record information, thereby avoiding repeated creation of the same schedule information.

In some embodiments, the first event parameter includes mailbox information, and the target application includes a mailbox application corresponding to the mailbox information. In some embodiments, the creating or updating event information corresponding to the first event parameter by means of a target application includes: sending an email to a mailbox corresponding to the mailbox information, the email containing event information generated based on the first event parameter. For example, if there is a column in the spreadsheet being the user's email address, information such as a conference link corresponding to the schedule can be sent to that email, and the user can join the conference corresponding to the schedule through the conference link in the email. In this way, the sending of the conference link and the participation in the conference are facilitated.

In some embodiments, the email contains conference information generated based on the first event parameter, which facilitates the generation and synchronization of conference information.

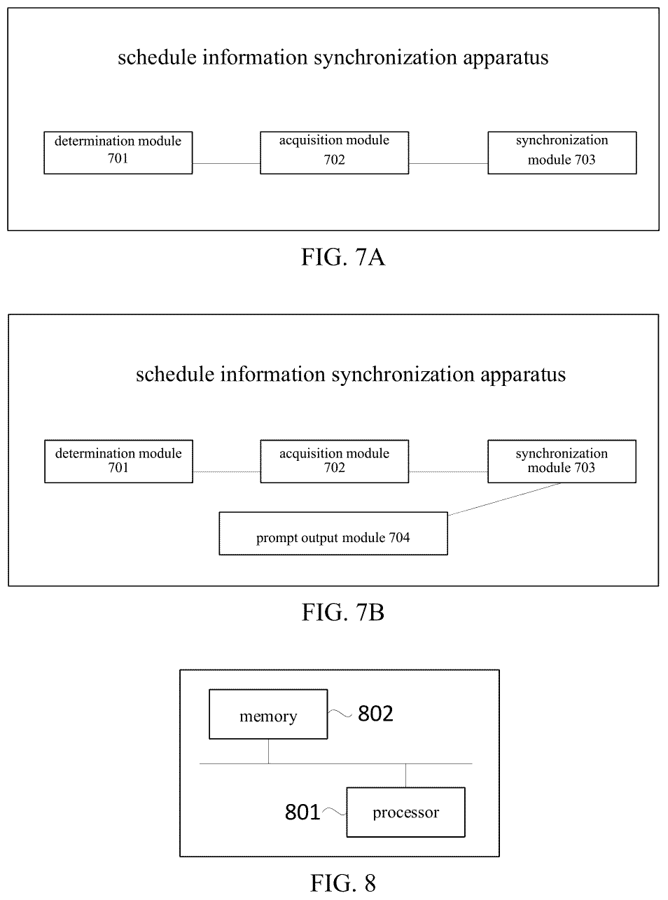

As shown in FIG. 7A, an embodiment of the present disclosure provides a first structural block diagram of a schedule information synchronization apparatus, including:
a determination module 701, configured to, in response to a preset trigger, determine first record information of a target event corresponding to the trigger, the first record information being record information in an event management application;
an acquisition module 702, configured to acquire a first event parameter of the target event from the first record information; and
a synchronization module 703, configured to, based on the first event parameter, create or update event information corresponding to the first event parameter by means of a target application.

As an optional implementation of the embodiments of the present disclosure, the based on the first event parameter, creating or updating event information corresponding to the first event parameter by means of a target application includes: based on the first event parameter, creating or updating first schedule information corresponding to the first event parameter by means of a target calendar.

The target calendar is a calendar configured to carry the first schedule information in a calendar application.

As an optional implementation of the embodiments of the present disclosure, the creating or updating first schedule information corresponding to the first event parameter by means of a target calendar includes: creating or updating conference information corresponding to the first schedule information.

As an optional implementation of the embodiments of the present disclosure, the target calendar is a calendar associated with the event management application in the calendar application.

As an optional implementation of the embodiments of the present disclosure, the synchronization module 703 is specifically configured to:
based on the first event parameter, create or update first schedule information corresponding to the first event parameter in the target calendar;
determine participant information corresponding to the first schedule information; and
create or update the first schedule information in personal calendars associated with the participant information.

As an optional implementation of the embodiments of the present disclosure, the synchronization module 703 is specifically configured to:
determine participant information corresponding to the first event parameter, the target calendar being a personal calendar associated with the participant information; and
based on the first event parameter, create or update the first schedule information in the personal calendar.

As an optional implementation of the embodiments of the present disclosure, the first event parameter includes at least one of the following information:
event time information, event location information, event description information, and participant information.

As an optional implementation of the embodiments of the present disclosure, the acquisition module 702 is specifically configured to:
determine a target progress status of the target event from the first record information; and
acquire the first event parameter corresponding to the target progress status.

As an optional implementation of the embodiments of the present disclosure, the first record information is record information in a target spreadsheet in the event management application.

The acquisition module 702 is specifically configured to:
determine at least one first field associated with the target progress status in the target spreadsheet; and
acquire at least one item of information from the at least one first field, and determining the first event parameter based on the at least one item of information.

As an optional implementation of the embodiments of the present disclosure, the synchronization module 703 is specifically configured to:
fill the at least one item of information into at least one second field of the first schedule information, wherein the at least one second field is a field in the first schedule information, and each second field is filled according to one or more items of the at least one item of information.

As an optional implementation of the embodiments of the present disclosure, the synchronization module is specifically configured to:
acquire an item of information from a first field, and splitting the item of information into a plurality of sub-information corresponding to a plurality of second fields; and
fill the plurality of sub-information into the plurality of second fields corresponding to the plurality of sub-information, respectively.

As an optional implementation of the embodiments of the present disclosure, the acquisition module 702 is specifically configured to:
determine a target progress status corresponding to the target event from the first record information, the target progress status being one of at least one progress status corresponding to the target event, different progress statuses in the at least one progress status corresponding to different event parameters, and different progress statuses in the at least one progress status corresponding to different schedule generation rules.

The synchronization module 703 is specifically configured to:
acquire a target schedule generation rule corresponding to the target progress status; and
based on the target schedule generation rule and the first event parameter, create or update first schedule information corresponding to the first event parameter by means of the target calendar.

As an optional implementation of the embodiments of the present disclosure, the target progress status includes: a current progress status or a future progress status.

As an optional implementation of the embodiments of the present disclosure, the first record information is record information in a target spreadsheet in the event management application.

The trigger includes a trigger operation on a synchronization control associated with the first record information.

As an optional implementation of the embodiments of the present disclosure, the determination module 701 is specifically configured to:
in response to the trigger operation, in the case where it is determined that a target calendar associated with the event management application exists in the calendar application, acquire first record information of a target event corresponding to the trigger operation;
alternatively,
in response to the trigger operation, in the case where it is determined that the target calendar associated with the event management application does not exist in the calendar application, create the target calendar, and acquire first record information of a target event corresponding to the trigger operation.

As an optional implementation of the embodiments of the present disclosure, the determination module 701 is also configured to:
determine essential elements of schedule information.

The synchronization module 703 is specifically configured to:
in the case where it is determined that the first event parameter includes information corresponding to the essential elements, based on the first event parameter, create or update first schedule information corresponding to the first event parameter on a target calendar.

In conjunction with FIG. 7A, as shown in FIG. 7B, a second structural block diagram of a schedule information synchronization apparatus provided in an embodiment of the present disclosure is provided. The schedule information synchronization apparatus also includes:
a prompt output module 704, configured to: in the case where the synchronization module 703 determined that the first event parameter does not include the information corresponding to the essential elements, output at least one of the following prompt messages:
a prompt message for prompting to supplement the information corresponding to the essential elements;
a prompt message for prompting a failure in creating the schedule information; and
a prompt message for prompting a failure in updating the schedule information.

As an optional implementation of the embodiments of the present disclosure, the synchronization module 703 is specifically configured to:
in the case where it is determined that second schedule information corresponding to the first record information exists in the target calendar, based on the first event parameter, update the second schedule information to the first schedule information corresponding to the first event parameter;
alternatively,
in the case where it is determined that the schedule information corresponding to the first record information does not exist in the target calendar, based on the first event parameter, create the first schedule information corresponding to the first event parameter in the target calendar.

As an optional implementation of the embodiments of the present disclosure, the first event parameter includes mailbox information, and the target application includes a mailbox application corresponding to the mailbox information. The creating or updating event information corresponding to the first event parameter by means of a target application includes: sending an email to a mailbox corresponding to the mailbox information, the email containing event information generated based on the first event parameter.

As an optional implementation of the embodiments of the present disclosure, the email contains conference information generated based on the first event parameter.

As shown in FIG. 8, an embodiment of the present disclosure provides an electronic device, including: a processor 801, a memory 802, and a computer program stored in the memory 802 and runnable on the processor 801. When the computer program is executed by the processor 801, various processes of the schedule information synchronization method in the above method embodiments are implemented, and the same technical effect can be achieved, which will not be repeated here to avoid repetition.

An embodiment of the present invention provides a computer-readable storage medium, which stores a computer program. When the computer program is executed by a processor, various processes of the schedule information synchronization method in the above method embodiments are implemented, and the same technical effect can be achieved, which will not be repeated here to avoid repetition.

The computer-readable storage medium may be a read-only memory (ROM), a random access memory (RAM), a magnetic disk or an optical disk, etc.

An embodiment of the present invention provides a computer program product, which stores a computer program. When the computer program is executed by a processor, various processes of the schedule information synchronization method in the above method embodiments are implemented, and the same technical effect can be achieved, which will not be repeated here to avoid repetition.

Those skilled in the art should understand that the embodiments of the present disclosure may be provided as methods, systems, or computer program products. Accordingly, the present disclosure may take the form of an entirely hardware embodiment, an entirely software embodiment, or an embodiment combining software and hardware aspects. Furthermore, the present disclosure may take the form of a computer program product implemented on one or more computer-usable storage media containing computer-usable program code therein.

In the present disclosure, the processor may be a central processing unit (CPU), or other general-purpose processors, digital signal processors (DSP), application specific integrated circuits (ASIC), field-programmable gate arrays (FPGA) or other programmable logic devices, discrete gate or transistor logic devices, discrete hardware components, etc. A general purpose processor may be a microprocessor, or the processor may be any conventional processor, etc.

In the present disclosure, the memory may include a non-permanent memory in a computer-readable medium, in the form of a random access memory (RAM) and/or a non-volatile memory such as a read-only memory (ROM) or a flash RAM. The memory is an example of the computer-readable medium.

In the present disclosure, computer-readable media include permanent and non-permanent, removable and non-removable storage media. The storage media may implement information storage by any method or technology, and the information may be computer-readable instructions, data structures, program modules or other data. Examples of computer storage media include, but are not limited to, a phase change memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disk read-only memory (CD-ROM), a digital versatile disk (DVD) or other optical storages, a magnetic cassette, magnetic disk storage or other magnetic storage devices, or any other non-transmission media that can be used to store information that can be accessed by a computing device. According to the definition herein, computer-readable media do not include temporary computer-readable media (transitory media), such as modulated data signals and carrier waves.

It should be noted that relational terms such as “first” and “second” herein are merely used to distinguish one entity or operation from another entity or operation, and do not necessarily require or imply any actual relationship or order between these entities or operations. Furthermore, the terms “includes”, “contains”, or any other variations thereof are intended to cover non-exclusive inclusion, such that a process, method, article, or device that includes a list of elements includes not only those elements but also other elements not expressly listed, or also includes elements inherent to such process, method, article, or device. Without more constraints, an element defined by the phrase “includes a . . . ” does not exclude the existence of other identical elements in the process, method, article or device including the element.

The above are merely specific implementations of the present disclosure, which enable those skilled in the art to understand or implement the present disclosure. Various modifications to these embodiments will be readily apparent to those skilled in the art, and the generic principles defined herein may be implemented in other embodiments without departing from the spirit or scope of the disclosure. Thus, the present disclosure will not be limited to the embodiments herein but will be accorded the widest scope consistent with the principles and novel features disclosed herein.

What is claimed is:

1. An information synchronization method, comprising:
in response to a preset trigger, determining first record information of a target event corresponding to the trigger, the first record information being record information in an event management application;
acquiring a first event parameter of the target event from the first record information; and
based on the first event parameter, creating or updating event information corresponding to the first event parameter by means of a target application.

2. The method according to claim 1, wherein the based on the first event parameter, creating or updating event information corresponding to the first event parameter by means of a target application comprises:
based on the first event parameter, creating or updating first schedule information corresponding to the first event parameter by means of a target calendar;
wherein the target calendar is a calendar configured to carry the first schedule information in a calendar application.

3. The method according to claim 2, wherein at least one of the following is satisfied:
the creating or updating first schedule information corresponding to the first event parameter by means of a target calendar comprises: creating or updating conference information corresponding to the first schedule information, or
the target calendar is a calendar associated with the event management application in the calendar application.

4. The method according to claim 3, wherein the based on the first event parameter, creating or updating first schedule information corresponding to the first event parameter by means of a target calendar comprises:
based on the first event parameter, creating or updating first schedule information corresponding to the first event parameter in the target calendar;
determining participant information corresponding to the first schedule information; and
creating or updating the first schedule information in personal calendars associated with the participant information.

5. The method according to claim 2, wherein the based on the first event parameter, creating or updating first schedule information corresponding to the first event parameter by means of a target calendar comprises:
determining participant information corresponding to the first event parameter, the target calendar being a personal calendar associated with the participant information; and
based on the first event parameter, creating or updating the first schedule information in the personal calendar.

6. The method according to claim 1, wherein the first event parameter comprises at least one of the following information:
event time information; event location information; event description information; or participant information.

7. The method according to claim 1, wherein at least one of the following is satisfied:
the acquiring a first event parameter of the target event from the first record information comprises: determining a target progress status of the target event from the first record information; acquiring the first event parameter corresponding to the target progress status;
or
the first record information is record information in a target spreadsheet in the event management application; the acquiring the first event parameter corresponding to the target progress status comprises: determining at least one first field associated with the target progress status in the target spreadsheet; acquiring at least one item of information from the at least one first field, and determining the first event parameter based on the at least one item of information.

8. The method according to claim 7, wherein the based on the first event parameter, creating or updating first schedule information corresponding to the first event parameter by means of a target calendar comprises:
filling the at least one item of information into at least one second field of the first schedule information, wherein the at least one second field is a field in the first schedule information, and one second field is filled according to one or more items of the at least one item of information.

9. The method according to claim 8, wherein the filling the at least one item of information into at least one second field of the first schedule information comprises:
acquiring an item of information from a first field, and splitting the item of information into a plurality of sub-information corresponding to a plurality of second fields; and
filling the plurality of sub-information into the plurality of second fields corresponding to the plurality of sub-information, respectively.

10. The method according to claim 7, wherein the determining a target progress status of the target event from the first record information comprises:
determining a target progress status corresponding to the target event from the first record information, the target progress status being one of at least one progress status corresponding to the target event, different progress statuses in the at least one progress status corresponding to different event parameters, and/or different progress statuses in the at least one progress status corresponding to different schedule generation rules;
the based on the first event parameter, creating or updating first schedule information corresponding to the first event parameter by means of a target calendar comprises:
acquiring a target schedule generation rule corresponding to the target progress status; and
based on the target schedule generation rule and the first event parameter, creating or updating first schedule information corresponding to the first event parameter by means of the target calendar.

11. The method according to claim 10, wherein the target progress status comprises: a current progress status or a future progress status.

12. The method according to claim 1, wherein the first record information is record information in a target spreadsheet in the event management application;
the trigger comprises a trigger operation on a synchronization control associated with the first record information.

13. The method according to claim 1, wherein the in response to a trigger operation from a user, determining first record information of a target event corresponding to the trigger operation comprises:
in response to the trigger operation, in the case where it is determined that a target calendar associated with the event management application exists in the calendar application, determining first record information of a target event corresponding to the trigger operation;
alternatively,
in response to the trigger operation, in the case where it is determined that the target calendar associated with the event management application does not exist in the calendar application, creating the target calendar, and determining first record information of a target event corresponding to the trigger operation.

14. The method according to claim 2, wherein before based on the first event parameter, creating or updating first schedule information corresponding to the first event parameter on a target calendar, the method also comprises:
determining essential elements of schedule information;
the based on the first event parameter, creating or updating first schedule information corresponding to the first event parameter on a target calendar comprises:
in the case where it is determined that the first event parameter comprises information corresponding to the essential elements, based on the first event parameter, creating or updating first schedule information corresponding to the first event parameter on a target calendar.

15. The method according to claim 14, also comprising:
in the case where it is determined that the first event parameter does not comprise the information corresponding to the essential elements, outputting at least one of the following prompt messages:
a prompt message for prompting to supplement the information corresponding to at least one essential element;
a prompt message for prompting a failure in creating the schedule information; and
a prompt message for prompting a failure in updating the schedule information.

16. The method according to claim 2, wherein the based on the first event parameter, creating or updating first schedule information corresponding to the first event parameter on a target calendar comprises:
in the case where it is determined that second schedule information corresponding to the first record information exists in the target calendar, based on the first event parameter, updating the second schedule information to the first schedule information corresponding to the first event parameter;
alternatively,
in the case where it is determined that the schedule information corresponding to the first record information does not exist in the target calendar, based on the first event parameter, creating the first schedule information corresponding to the first event parameter in the target calendar.

17. The method according to claim 1, wherein at least one of the following is satisfied:
the preset trigger is a trigger that occurs in the event management application; or
the first event parameter comprises mailbox information, and the target application comprises a mailbox application corresponding to the mailbox information; the creating or updating event information corresponding to the first event parameter by means of a target application comprises: sending an email to a mailbox corresponding to the mailbox information, the email containing event information generated based on the first event parameter.

18. The method according to claim 17, wherein the email contains conference information generated based on the first event parameter.

19. An electronic device, characterized in comprising: a processor, a memory, and a computer program stored in the memory and runnable on the processor, when the computer program is executed by the processor, the following operations being implemented:
in response to a preset trigger, determining first record information of a target event corresponding to the trigger, the first record information being record information in an event management application;
acquiring a first event parameter of the target event from the first record information; and
based on the first event parameter, creating or updating event information corresponding to the first event parameter by means of a target application.

20. A non-transitory computer-readable storage medium, characterized in comprising: a computer program stored on the computer-readable storage medium, when the computer program is executed by a processor, the following operations being implemented:
in response to a preset trigger, determining first record information of a target event corresponding to the trigger, the first record information being record information in an event management application;
acquiring a first event parameter of the target event from the first record information; and
based on the first event parameter, creating or updating event information corresponding to the first event parameter by means of a target application.
